(19) United States
(12) Patent Application Publication
(10) Pub. No.: US 2012/0217972 A1
(43) Pub. Date: Aug. 30, 2012

(54) METHOD FOR SETTING THE PERIOD FOR MEASURING VOLTAGE LEVEL OF A BATTERY IN A MOBILE DEVICE AND MOBILE DEVICE ADAPTED THERETO

(75) Inventor: Jae Yong SHIN, Seoul (KR)

(73) Assignee: SAMSUNG ELECTRONICS CO. LTD., Suwon-si (KR)

(21) Appl. No.: 13/108,364

(22) Filed: May 16, 2011

(30) Foreign Application Priority Data
Feb. 25, 2011 (KR) 10-2011-0016880

(51) Int. Cl. G01N 27/416

(52) U.S. Cl. 324/427

(57) ABSTRACT

A method and apparatus for setting a period for measuring voltage level of a battery are provided. The method includes determining whether the period for measuring the battery voltage level has elapsed, measuring battery voltage level when the period for measuring voltage level has elapsed, extracting and displaying a remaining battery capacity based on the measured battery voltage level, and setting the period for measuring battery voltage level based on the measured battery voltage level.

### PRIORITY

This application claims the benefit under 35 U.S.C. §119(a) of a Korean patent application filed on Feb. 25, 2011 in the Korean Intellectual Property Office and assigned Serial No. 10-2011-0016880, the entire disclosure of which is hereby incorporated by reference.

### BACKGROUND OF THE INVENTION

1. Field of the Invention

The present invention relates to electronic communication systems. More particularly, the present invention relates to a method that sets the period for measuring the voltage level of a battery in a mobile device, considering the discharge characteristics of the battery, and also to a mobile device adapted to the method.

2. Description of the Related Art

Conventional mobile devices were developed to provide only their respective inherent functions. For example, mobile phones provided only a call function and electronic dictionary devices only provided a dictionary function. However, with the development of technology and the increase in user functions, mobile devices were developed to provide a variety of functions. For example, a smart phone can provide games, document writing, navigation, etc., via applications. With the increasing variety of functions that one mobile device can provide, concern has also been raised about the use of a mobile device's battery. Conventional mobile devices measure the voltage level of the battery according to a preset period, calculate the remaining battery capacity acquired from the measured voltage level, and display it on the display unit. However, since conventional mobile devices have a fixed period for measuring voltage level of the battery, they perform the voltage level measuring process unnecessarily.

FIG. 1 illustrates a flow chart that describes a method for setting the period for charging a battery according to the related art.

Referring to FIG. 1, a mobile device is switched on or connected to a recharger in step 110. The controller determines whether the mobile device is connected to a battery in step 120. When the controller ascertains that the mobile device is not connected to a battery in step 130, the controller turns off the mobile device in step 190. When the controller ascertains that the mobile device is connected to a battery in step 130, the controller determines whether the mobile device is connected to the recharger in step 140.

When the controller ascertains that the mobile device is connected to the recharger at step 140, the controller enters a charge mode in step 150, and operates a timer at the period T2 in step 180. When the controller ascertains that the mobile device is not connected to the recharger at step 140, the controller enters a normal mode in step 160, and operates a timer at the period T1 in step 170. When a period of time T1 or T2 has elapsed, the controller measures the voltage level of the battery and then proceeds with step 120.

As described above, the method shown in FIG. 1 only measures the voltage level of the battery according to the predetermined periods that were set according to whether the mobile device is connected to a recharger. Therefore, the conventional voltage level measurement method is disadvantageous in that the voltage level is measured even though it is unnecessary or measured according to set time periods.

### SUMMARY OF THE INVENTION

Aspects of the present invention are to address at least the above-mentioned problems and/or disadvantages and to provide at least the advantages described below. Accordingly, an aspect of the present invention is to provide a method for setting the period for measuring battery voltage level that can measure battery voltage level at a time point when it is required, reducing the frequency of measuring battery voltage level, thereby reducing the power consumption of the battery.

Another aspect of the present invention is to provide a mobile device adapted to the method.

In accordance with an aspect of the present invention, a method for setting the period for measuring the voltage level of a battery in a mobile device is provided. The method includes determining whether the period for measuring the battery voltage level has elapsed, measuring battery voltage level when the period for measuring voltage level has elapsed, extracting and displaying a remaining battery capacity based on the measured battery voltage level, and setting the period for measuring battery voltage level based on the measured battery voltage level.

In accordance with another aspect of the present invention, a mobile device for setting a period for measuring a voltage level of a battery in the mobile device is provided. The mobile device includes a voltage level measuring unit for measuring the battery voltage level and for extracting a remaining battery capacity based on the measured battery voltage level, a display unit for displaying the extracted remaining battery capacity, a period setting unit for setting the period for measuring voltage level based on the measured battery voltage level, and a battery measurement controlling unit for measuring, when the period for measuring voltage level has elapsed, the battery voltage level and for resetting the period for measuring the battery voltage level.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 illustrates a flowchart that describes a method for setting the period for charging a battery according to the related art;

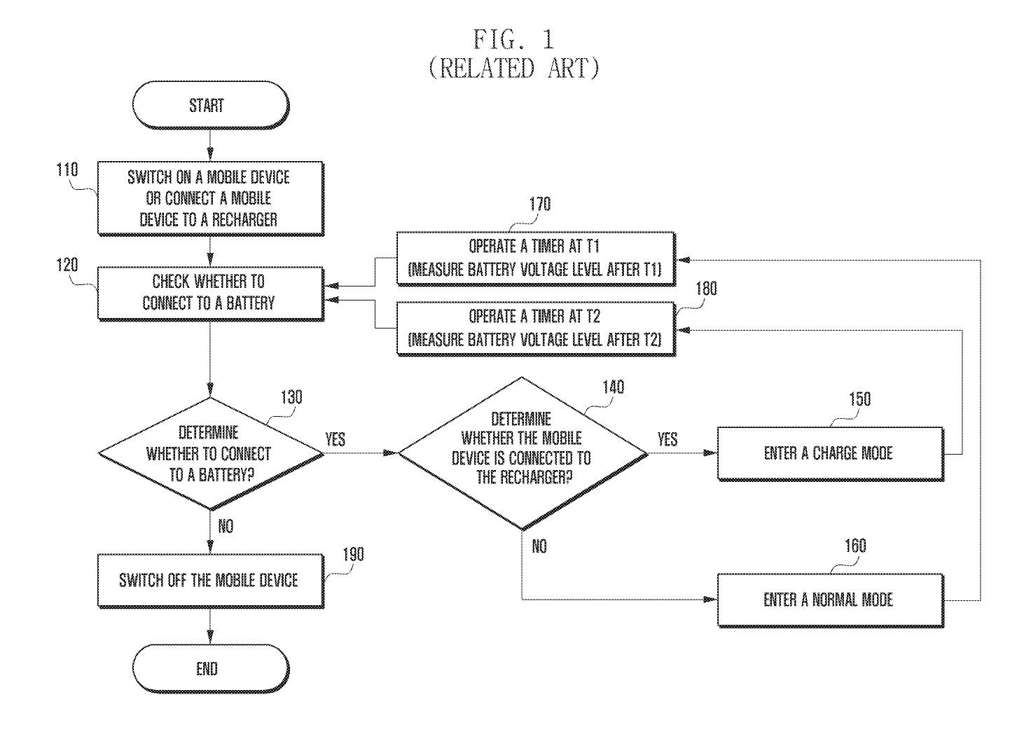

FIG. 2 illustrates a schematic block diagram of a mobile device according to an exemplary embodiment of the present invention;

FIG. 3 illustrates a flowchart that describes a method for setting the period for measuring battery voltage level in a mobile device, according to an exemplary embodiment of the present invention;

FIG. 4 illustrates a flowchart that describes step 350 in the method shown in FIG. 3 according to an exemplary embodiment of the present invention;

FIG. 5 illustrates a discharge characteristic graph of a lithium-ion battery according to an exemplary embodiment of the present invention; and

FIG. 6 illustrates a flowchart that describes a method for setting the period for measuring battery voltage level in a mobile device, according to another exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The following description provides a method for setting the period for measuring battery voltage level and a mobile device adapted to the method, referring to the accompanying drawings.

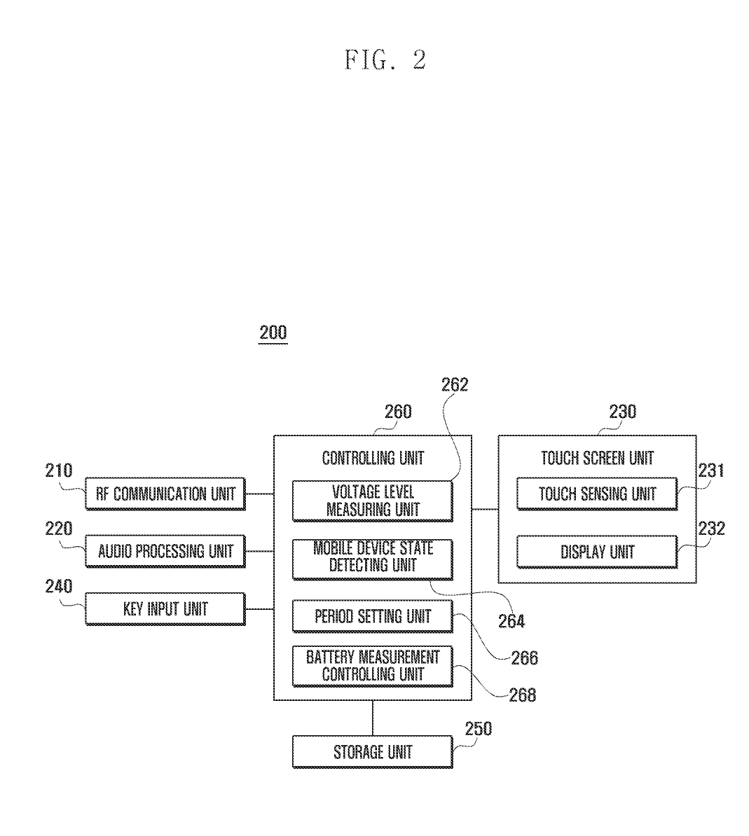

FIG. 2 illustrates a schematic block diagram of a mobile device 200 according to an exemplary embodiment of the present invention.

Referring to FIG. 2, the mobile device 200 includes a Radio Frequency (RF) communication unit 210, an audio processing unit 220, a touch screen unit 230, a key input unit 240, a storage unit 250, and a controlling unit 260. The mobile device 200 may include additional and/or different units. Similarly, the functionality of two or more of the above units may be integrated into a single component.

The RF communication unit 210 performs RF communication to transmit/receive data to/from external systems. The RF communication unit 210 includes an RF transmitter for up-converting the frequency of signals to be transmitted and amplifying the signals and an RF receiver for low-noise amplifying received RF signals and down-converting the frequency of the received RF signals. The RF communication unit 210 receives data via an RF channel and outputs the data to the controlling unit 260. The RF communication unit 210 also transmits data, output from the controlling unit 260, via an RF channel.

The audio processing unit 220 includes coders and decoders (codecs). The codecs include a data codec for processing packet data, etc. and an audio codec for processing audio signals, such as voice signals, etc. The audio codec converts digital audio signals into analog audio signals and outputs them via a speaker. The audio codec also converts analog audio signals, received via a microphone, into digital audio signals.

The touch screen unit 230 includes a touch sensing unit 231 and a display unit 232. The touch sensing unit 231 senses a user's touch. The touch sensing unit 231 may be implemented with various types of touch sensors, for example, a capacitive overlay type sensor, a resistive overlay type sensor, an infrared beam type sensor, a pressure sensor, etc. Exemplary embodiments of the present invention are not limited to the sensors listed above. The touch sensing unit 231 may be implemented with any type of sensor that can sense touch or contact. The touch sensing unit 231 senses a user's touch, creates a touch sensed signal, and outputs the signal to the controlling unit 260. The touch sensed signal includes data regarding a coordinate where the user touches the touch screen unit 230. When the user gestures a touch location movement, the touch sensing unit 231 creates a touch sensed signal containing coordinate data regarding the touch location movement path and outputs it to the controlling unit 260.

The display unit 232 may be implemented with a Liquid Crystal Display (LCD), an Organic Light Emitting Diode (OLED), an Active Matrix Organic Light Emitting Diodes (AMOLED), or the like. The display unit 232 displays menus, input data, function-setting information, and addition information. For example, the display unit 232 displays a booting screen, an idle screen, a menu screen, a call screen, and application executing screens of the mobile device 200. The display unit 232 may display the remaining battery capacity acquired from the measurement of battery voltage level.

Although the mobile device 200 is shown with a touch screen unit 230 as described above, the touch screen 230 may be omitted. In this case, the touch screen unit 230 may include a display unit 232, or may perform a function of the display unit 232.

The key input unit 240 receives a user's key operating signals for controlling the mobile device 200, and outputs the operating signals to the controlling unit 260. The key input unit 240 may be implemented with a keypad with alphanumeric keys and direction keys. The key input unit 240 may be implemented as function keys on one side of the mobile device 200. When the mobile device 200 is implemented so that it can be operated by only the touch screen unit 230, the key input unit 240 may be omitted.

The storage unit 250 stores programs required to operate the mobile device 200 and data generated when the programs are executed. The storage unit 250 includes a program storage area and a data storage area. The program storage area stores a program for controlling the entire operation of the mobile device 200 and an Operating System (OS) for booting the mobile device 200. The program storage area also stores applications related to a variety of functions, such as multimedia content playback, a camera function, audio file playback function, image or video playback function, and the like. The data storage area stores data generated when the mobile device 200 is used. For example, the data storage area stores images, videos, phone book data, audio data, etc.

The controlling unit 260 controls operations of the components in the mobile device 200. The controlling unit 260 includes a voltage level measuring unit 262, a mobile device state detecting unit 264, a period setting unit 266, and a battery measurement controlling unit 268.

The voltage level measuring unit 262 measures the voltage level of a battery connected to the mobile device 200. The measured battery voltage level is used to set the period for measuring battery voltage level and to estimate the remaining battery capacity.

The mobile device state detecting unit 264 detects a function performing state of the mobile device 200. The function performing state may be an idle state, a video call state, a voice call state, a video recording state, and the like. The function performing state is determined according to which function the mobile device 200 is performing.

The period setting unit 266 sets the period for measuring battery voltage level, based on battery voltage level measured by the voltage level measuring unit 262 and a function performing state detected by the mobile device state detecting unit 264. The period setting unit 266 may alternatively set the period for measuring battery voltage level, based on battery voltage level or a function performing state. The period setting unit 266 sets a first parameter according to battery voltage level measured by the voltage level measuring unit 262 and a second parameter according to a function performing state detected by the mobile device state detecting unit 264. The period setting unit 266 sets the period for measuring battery voltage level, based on the first and second parameters. For example, the period setting unit 266 may set the period for measuring battery voltage level by multiplying the first and second parameters.

The period setting unit 266 may set the period for measuring voltage level in such a manner that the larger the slope of the battery discharge curve in the battery voltage level, measured by the voltage level measuring unit 262, the shorter the measurement period. Alternatively, the period setting unit 266 may set the period for measuring battery voltage level in such a manner that the larger the function performing state of the mobile device 200, measured by the mobile device state detecting unit 264 requires power consumption, the shorter the measurement period. In addition, when the mobile device 200 changes its operation mode (or function performing state) from an idle state to an active state, i.e., states other than the idle state, the period setting unit 266 can measure the battery voltage level and then re-set the period for measuring battery voltage level, based on the measured battery voltage level and the function performing state.

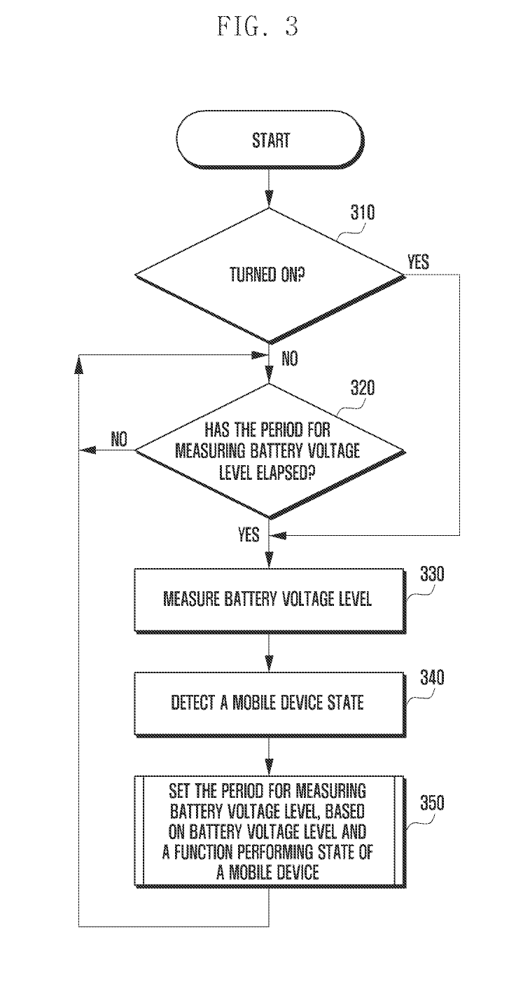

An exemplary configuration and operation of the controlling unit 260 will be described in detail below with respect to FIGS. 3 to 6.

FIG. 3 illustrates a flowchart that describes a method for setting the period for measuring battery voltage level in a mobile device, according to an exemplary embodiment of the present invention.

Referring to FIG. 3, the controlling unit 260 of the mobile device 200 determines whether the mobile device 200 initially receives electric power in step 310. This refers to a state where the period for measuring battery voltage level is not set or a state where a setting is made to measure battery voltage level within a short time (or immediately) after electric power is supplied to the mobile device 200. When the mobile device 200 initially receives electric power at step 310, the battery voltage level is measured in step 330.

When the mobile device 200 does not initially receive electric power at step 310, the battery measurement controlling unit 268 determines whether the period for measuring battery voltage level has elapsed in step 320. When the period for measuring battery voltage level has not elapsed in step 320, the battery measurement controlling unit 268 repeats step 320 until the period for measuring battery voltage level has elapsed.

When the period for measuring battery voltage level has elapsed in step 320, the voltage level measuring unit 262 measures the voltage level of the battery connected to the mobile device 200 at step 330. Since methods for measuring battery voltage level are well known to persons skilled in the art, a detailed description will be omitted in this description. The voltage level measuring unit 262 calculates the remaining battery capacity based on the measured battery voltage level. The display unit 232 displays the remaining battery capacity. The mobile device state detecting unit 264 detects a function performing state of the mobile device 200 in step 340. As described above with respect to FIG. 2, the function performing state of the mobile device 200 is determined according to a function that the mobile device 200 performs.

In step 350, the period setting unit 266 sets the period for measuring voltage level, based on the battery voltage level measured at step 330 and the function performing state determined at step 340.

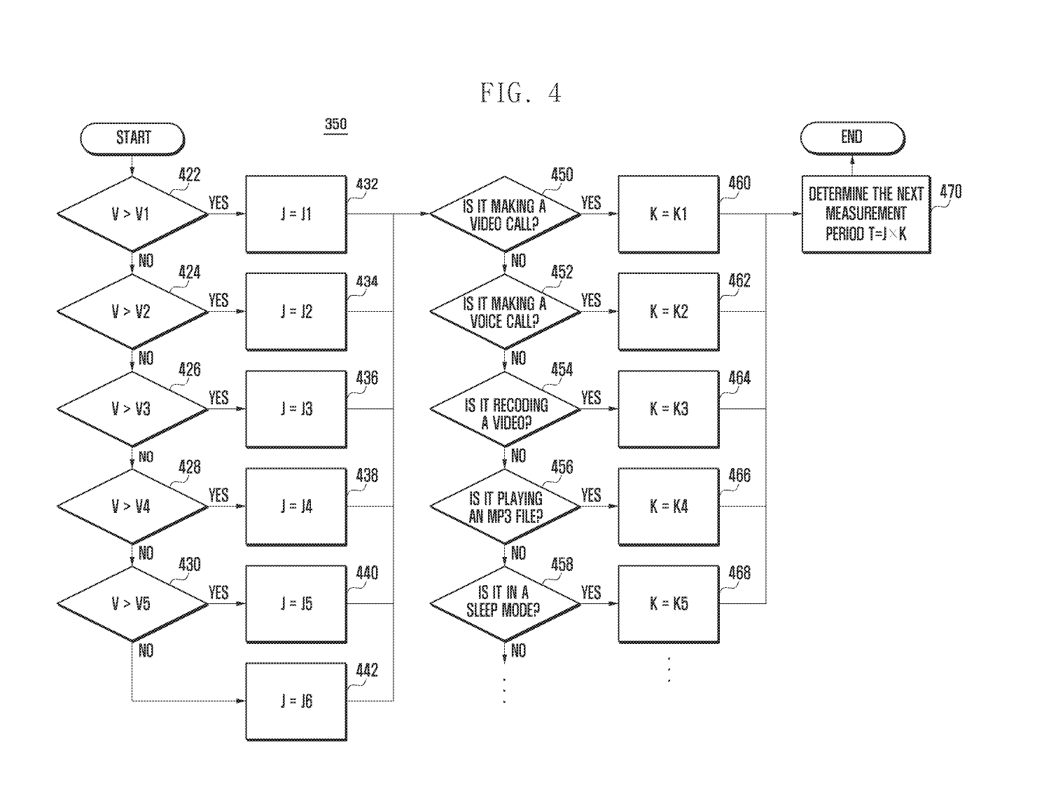

FIG. 4 illustrates a flowchart that describes step 350 in the method shown in FIG. 3 according to an exemplary embodiment of the present invention.

Referring to FIG. 4, the period setting unit 266 determines which voltage level section the battery voltage level, measured at step 330, corresponds to in steps 422, 424, 426, 428, and 430. After detecting a voltage level section corresponding to the measured battery voltage level, the period setting unit 266 sets a first parameter J according to the voltage level section at steps 432, 434, 436, 438, 440, and 442.

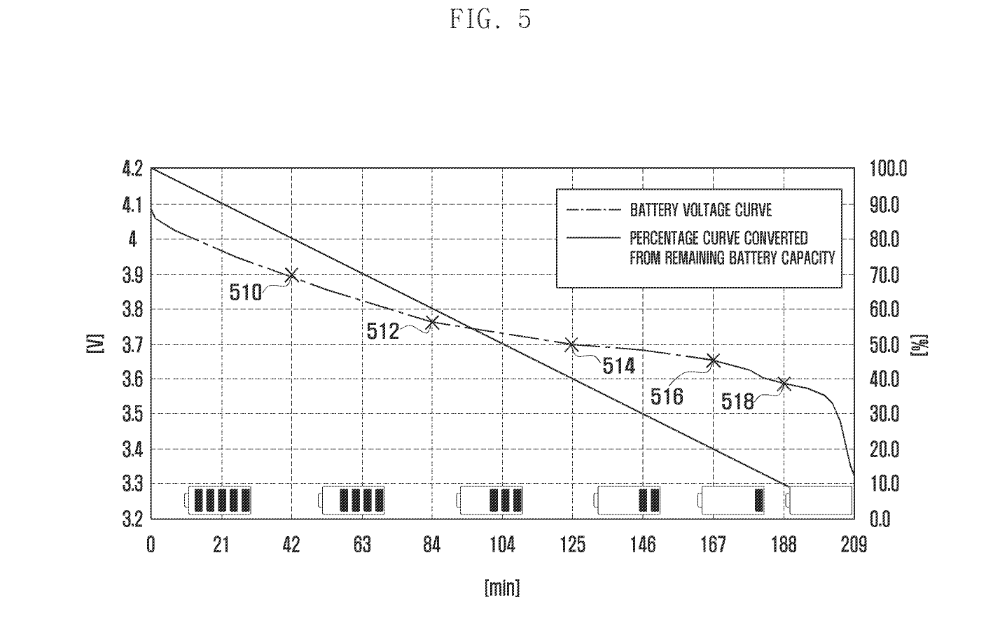

FIG. 5 illustrates a discharge characteristic graph of a lithium-ion battery according to an exemplary embodiment of the present invention.

Referring to FIG. 5, the graph shows a discharge curve when a 1000 mAh lithium-ion battery is discharged with a consumption current of 290 mA. The symbols Xs (510, 512, 514, 516, and 518) on the discharge curve represent the battery voltage levels, 3.89, 3.77, 3.70, 3.64, and 3.58 Volts at the points, 80%, 60%, 40%, 20%, and 10% of the remaining battery capacity, respectively. In the following description, for the sake of convenience, the battery voltage levels, 3.89, 3.77, 3.70, 3.64, and 3.58 Volts are called V1, V2, V3, V4, and V5, respectively. The discharge curve shows different slopes at each voltage level section, and this means that the lithium-ion battery discharges at a different rate at corresponding sections.

Referring to the discharge curve, when the slope of the curve is steep in a section corresponding to the current battery voltage level, the voltage variation is large. In that case, the battery voltage level should be frequently measured. When the slope of the curve is gentle in a section corresponding to the current battery voltage level, this means that the voltage variation is small, so the battery voltage level does not need to be frequently measured. Therefore, the period for measuring battery voltage level should be set differently according to the voltage level sections. For example, the period for measuring battery voltage level may be set as six different types in the voltage level sections as shown in the following table 1.

TABLE 1

| | V > V1 | V1 ≧ V > V2 | V2 ≧ V > V3 | V3 ≧ V > V4 | V4 ≧ V > V5 | V5 ≧ V |
|---|---|---|---|---|---|---|
| Voltage | V > 3.89 | 3.89 ≧ V > 3.77 | 3.77 ≧ V > 3.70 | 3.70 ≧ V > 3.64 | 3.64 ≧ V > 3.58 | 3.58 ≧ V |
| level | | | | | | |
| section | | | | | | |
| [Volts] | | | | | | |
| | J1 | J2 | J3 | J4 | J5 | J6 |
| Period | 20 | 40 | 50 | 60 | 10 | 1 |
| [mins] | | | | | | |

Although the total battery voltage level is divided into 6 sections as shown in Table 1, it should be understood that the present invention is not limited to this exemplary embodiment. For example, the divided voltage levels may each be further divided into sub-sections so that the period for measuring battery voltage level can be more accurately set. The voltage level section vs. period mapping table, as described in Table 1, may be stored in the storage unit 250 or, as program codes, in the period setting unit 266. The voltage level section vs. period mapping table may be set by the mobile device manufacturers, software providers, or users. When the slope of the discharge curve is steep in a particular voltage level section, the period for measuring battery voltage level is set to be short in that section. When the slope of the discharge curve is gentle in a voltage level section, the period for measuring battery voltage level is set to be long in that section.

Referring back to FIG. 4, the period setting unit 266 sets the period of measuring battery voltage level, i.e., the first parameter J, referring to the voltage level section vs. period mapping table, Table 1, at steps 422 to 442. The period for measuring battery voltage level may alternatively be set as the parameter J acquired at steps 422 to 442, without performing steps 450 to 468. In that case, the period for measuring voltage level, J, may be altered via the function performing state of the mobile device 200.

At steps 450 to 468, the period setting unit 266 sets a period correction value (second parameter) K, according to the function performing state of the mobile device 200 detected at step 340.

The discharge characteristic graph, illustrated in FIG. 5, shows the measurement of the battery voltage level when the battery is discharged with consumption current 290 mA. When consumption current varies in a battery, the discharge time also varies. The real slope of the discharge characteristic curve varies depending on consumption current. However, when it is assumed that the battery is discharged with the same consumption current, the relative variation of the slope of the battery discharge characteristic curve shows the same curve as FIG. 5. Therefore, in order to increase precision, the periods of measuring battery voltage level by voltage level sections can be corrected, considering consumption current according to the functions that the mobile device currently performs. The period for measuring battery voltage level can be corrected in such a way that it is shortened when the mobile device 200 performs a function requiring a relatively large amount of current, such as a video or voice call, and elongated when the mobile device 200 is in an idle state.

The function performing state corresponds to information regarding which function the mobile device 200 performs. The period correction value K according to function performing states may be set as in the following Table 2.

TABLE 2

| Function performing states | Correction value (K) |
|---|---|
| Video call | 1/40 |
| Voice call | 1/30 |
| Video Recording | 1/20 |
| MP3 file playback | 1/10 |
| Idle state | 2 |

In the example shown in Table 2, since the mobile device 200 consumes a large amount of current during the voice call, the discharge characteristics curve has a steep slope. In that case, the period for measuring voltage level J is multiplied by correction value K of 1/30, so the battery voltage level is measured according to the corrected period that is relatively short. On the other hand, since the mobile device 200 consumes a relatively small amount of current during the idle mode, the slope of the discharge characteristics curve is gentle during the idle mode. In that case, the period for measuring voltage level J is multiplied by correction value K of 2, so the battery voltage level is measured according to the corrected period that is relatively long.

As shown in Table 2, the function performing state vs. correction value table can be stored in the storage unit 250 or, as program codes, in the controlling unit 260. The function performing state vs. correction value table may be set by the mobile device manufacturers, software providers, or users.

Although the function performing state vs. correction value table is described based on six types of function performing states, the function performing state vs. correction value table may store more than six function performing states and correction values Ks corresponding thereto.

The period setting unit 266 extracts a correction value K corresponding to a function performing state of the mobile device 200, referring to the function performing state vs. correction value table.

The period setting unit 266 multiplies the period J and the correction value K, and sets the final period of measuring battery voltage level, T, at step 470. When the final period T has elapsed, the battery measurement controlling unit 268 reverts to step 320 in the flow chart of FIG. 3 and senses that a period of measuring battery voltage level has elapsed. The battery measurement controlling unit 268 controls the voltage level measuring unit 262 and the mobile device state detecting unit 264 to perform steps 330 and 340.

As described above with respect to FIG. 5, the fundamental period (first parameter, J) and the correction value K (second parameter, K) are acquired according to the battery voltage level and the function performing state of the mobile device 200, respectively, and then the period for measuring battery voltage level is set by multiplying the first parameter J and the second parameter K. However, the fundamental period and the correction value may be acquired according to the function performing state and the battery voltage level, respectively. In addition, the period for measuring battery voltage level may be set according to the function performing state of the mobile device 200 irrespective of the battery voltage level. Similarly, instead of multiplying the first parameter J and the second parameter K, other operations, such as an addition operation, a squaring operation, a logarithm operation, and the like, may also be applied to acquiring the period for measuring battery voltage level.

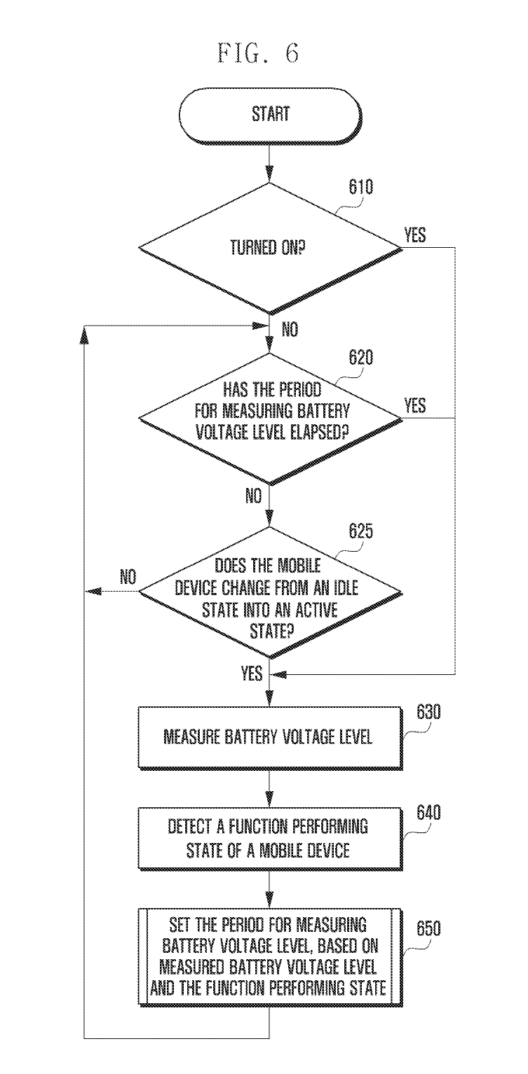

FIG. 6 illustrates a flowchart that describes a method for setting the period for measuring battery voltage level in a mobile device, according to another exemplary embodiment of the present invention.

Referring to FIG. 6, the exemplary embodiment of the method shown in FIG. 6 is similar to the exemplary embodiment described with respect to FIG. 3, by adding thereto a process when a function performing state of the mobile device 200 is altered. When the period for measuring battery voltage level is determined when the mobile device 200 is in an idle state, the battery voltage level is measured after a relatively long period that has elapsed. When the period for measuring battery voltage level is determined as such and the mobile device 200 enters an active state to perform a voice call, video call, or other function, the mobile device 200 may experience battery failure. Although the period for measuring battery voltage level was set assuming that the mobile device 200 will be in an idle state, when the mobile device 200 is activated, the slope of the discharge characteristic curve is steep. In that case, the battery voltage level should be measured at a relatively short period. When the mobile device 200 is an activated state, the period for measuring battery voltage level should be reset, as shown in FIG. 6.

The controlling unit 260 of the mobile device 200 determines whether the mobile device 200 initially receives electric power in step 610. This refers to a state where the period for measuring battery voltage level is not set or a state where a setting is made to measure battery voltage level within a short time (or immediately) after electric power is supplied to the mobile device 200. When the mobile device 200 initially receives electric power at step 610, the battery voltage level is measured in step 630.

When the mobile device 200 does not initially receive electric power at step 610, the battery measurement controlling unit 268 determines whether the period for measuring battery voltage level has elapsed in step 620. When the period for measuring battery voltage level has elapsed at step 620, the battery voltage level is measured at step 630.

When the period for measuring battery voltage level has not elapsed at step 620, the battery measurement controlling unit 268 determines whether the function performing state of the mobile device 200 is altered from an idle state to an activated state in step 625. When the battery measurement controlling unit 268 ascertains that the function performing state of the mobile device 200 is altered from an idle state to an activated state at step 625, the battery measurement controlling unit 268 measures the battery voltage level at step 630. When the battery measurement controlling unit 268 ascertains that the function performing state of the mobile device 200 is not altered from an idle state to an activated state or is altered from an activated state to an idle state at step 625, the battery measuring controlling unit 268 reverts to step 620 and waits until the period for measuring battery voltage level has elapsed. The battery measurement controlling unit 268 monitors whether the mobile device 200 is activated from an idle state. The battery measurement controlling unit 268 remeasures the battery voltage level when the mobile device 200 is altered from an idle state to an activated state, and then re-sets the period for measuring battery voltage level. Through these processes, the problem where the battery voltage level is not measured while the mobile device 200 is used in an activated state can be avoided.

As the other steps 630, 640, and 650 are similar to steps 330, 340, and 350 as shown in FIG. 3, their descriptions will be omitted.

As described above, the method for setting the period for measuring battery voltage level, according to exemplary embodiments of the present invention, can measure battery voltage level at a time point when it is necessarily required, reducing the frequency of measuring battery voltage level, thereby reducing the power consumption of the battery.

In addition, it should be understood that the process and the operations of the mobile device can be performed via computer programming instructions. These computer programming instructions can be executed by processors of data processing equipment that can be programmed, special computers, or universal computers. The instructions, performed via the processors of data processing equipment or the computers, can generate means that perform functions described in blocks of the flowchart. In order to implement functions in a particular mode, the computer programming instructions can also be stored in a computer available memory or computer readable memory that can support computers or data processing equipment that can be programmed. Therefore, the instructions, stored in the computer available memory or computer readable memory, can be installed to the products, and perform the functions therein, described in the blocks of the flowchart therein. In addition, since the computer programming instructions can also be installed to computers or data processing equipment that can be programmed, they can create processes that perform a series of operations therein, described in the blocks of the flowchart therein.

The blocks of the flow chart refer to part of codes, segments, or modules that include one or more executable instructions to perform one or more logic functions. It should be noted that the functions described in the blocks of the flow chart may be performed in a different order from the embodiments described above. For example, the functions described in two adjacent blocks may be performed at the same time or in reverse order.

The term ‘˜unit,’ refers to a software element or a hardware element such as a Flexible Printed Circuit Board (FPGA), an Application Specific Integrated Circuit (ASIC), etc., and performs a corresponding function. It should, however, be understood that the component ‘˜unit’ is not limited to a software or hardware element. The component ‘˜unit’ may be implemented in storage media that can be designated by addresses. The component ‘˜unit’ may also be configured to regenerate one or more processors. For example, the component ‘˜unit’ may include various types of elements (e.g., software elements, object-oriented software elements, class elements, task elements, etc.), segments (e.g., processes, functions, achieves, attribute, procedures, sub-routines, program codes, etc.), drivers, firmware, micro-codes, circuit, data, data base, data structures, tables, arrays, variables, etc. Functions provided by elements and the components ‘˜units’ may be formed by combining the small number of elements and components ‘˜units’ or may be divided into additional elements and components ‘˜units.’ In addition, elements and components ‘˜units’ may also be implemented to regenerate one or more CPUs in devices or security multi-cards.

However, while some units may be implemented as hardware or software or a combination thereof, it would be understood that some of the units would require at least one hardware component in order to carry out their functions.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for setting the period for measuring the voltage level of a battery in a mobile device, the method comprising:
determining whether the period for measuring battery voltage level has elapsed;
measuring battery voltage level when the period for measuring voltage level has elapsed;
extracting and displaying a remaining battery capacity based on the measured battery voltage level; and
setting the period for measuring battery voltage level based on the measured battery voltage level.

2. The method of claim 1, wherein the setting of the period for measuring battery voltage level comprises:
detecting a function performing state of the mobile device; and
setting the period for measuring battery voltage level based on the measured battery voltage level and the detected function performing state.

3. The method of claim 2, wherein the setting of the period for measuring battery voltage level comprises:
setting a first parameter according to the measured battery voltage level;
setting a second parameter according to the detected function performing state; and
setting the period for measuring battery voltage level, according to the first and second parameters.

4. The method of claim 2, wherein the setting of the period for measuring battery voltage level comprises:
setting a first parameter according to the measured battery voltage level;
setting a second parameter according to the detected function performing state; and
setting the period for measuring battery voltage level by multiplying the first and second parameters.

5. The method of claim 1, wherein the setting of the period for measuring battery voltage level comprises:
setting the period for measuring battery voltage level shorter as the slope of the battery discharge characteristic curve of the measured battery voltage level becomes steeper.

6. The method of claim 2, wherein the setting of the period for measuring battery voltage level comprises:
setting the period for measuring battery voltage level shorter as the function performing state of the mobile device requires larger power consumption.

7. The method of claim 2, further comprising:
measuring the battery voltage level when the function performing state is altered from an idle state to an activated state; and
resetting the period for measuring battery voltage level based on the measured battery voltage level and the function performing state.

8. A mobile device for setting a period for measuring a voltage level of a battery of the mobile device, the mobile device comprising:
a voltage level measuring unit for measuring the battery voltage level and for extracting a remaining battery capacity based on the measured battery voltage level;
a display unit for displaying the extracted remaining battery capacity;
a period setting unit for setting the period for measuring voltage level based on the measured battery voltage level; and
a battery measurement controlling unit for measuring, when the period for measuring voltage level has elapsed, the battery voltage level and for resetting the period for measuring the battery voltage level.

9. The mobile device of claim 8, further comprising:
a mobile device state detecting unit for detecting a function performing state of the mobile device,
wherein the period setting unit sets the period for measuring voltage level, based on the measured battery voltage level and the detected function performing state.

10. The mobile device of claim 9, wherein the period setting unit sets first and second parameters according to the measured battery voltage level and the detected function performing state, respectively, and sets the period for measuring battery voltage level, according to the first and second parameters.

11. The mobile device of claim 9, wherein the period setting unit sets first and second parameters according to the measured battery voltage level and the detected function performing state, respectively, and sets the period for measuring battery voltage level by multiplying the first and second parameters.

12. The mobile device of claim 8, wherein the period setting unit sets the period for measuring battery voltage level shorter as the slope of the battery discharge characteristic curve of the measured battery voltage level becomes steeper.

13. The mobile device of claim 9, wherein the period setting unit sets the period for measuring battery voltage level shorter as the function performing state of the mobile device requires larger power consumption.

14. The mobile device of claim 9, wherein the period setting unit measures the battery voltage level when the function performing state is altered from an idle state to an activated state, and resets the period for measuring battery voltage level based on the measured battery voltage level and the function performing state.
